(19) United States
(12) Patent Application Publication
(10) Pub. No.: US 2018/0371970 A1
(43) Pub. Date: Dec. 27, 2018

(54) METHOD FOR SEPARATE LUBRICATION OF A DRIVE SYSTEM FOR A MOTOR VEHICLE

(71) Applicant: TOTAL MARKETING SERVICES, Puteaux (FR)

(72) Inventors: Pierre DAVERAT, Vourles (FR); Nicolas OBRECHT, Meistratzheim (FR); Julien GUERIN, Villeurbanne (FR)

(21) Appl. No.: 15/775,277

(22) PCT Filed: Nov. 10, 2016
(86) PCT No.: PCT/EP2016/077212

§ 371 Date: May 10, 2018

(30) Foreign Application Priority Data
Nov. 13, 2015 (FR) 1560871

(51) Int. Cl. F01M 9/02; F01M 9/10; F02B 39/14; C10M 101/02; C10M 143/12; C10M 145/14; C10M 135/18; C10M 133/44; C10M 129/10; C10M 135/10; C10M 129/26; C10M 137/10; C10M 129/54; C10M 133/04

(52) U.S. Cl. CPC F01M 9/02; C10N 2240/10; F02B 39/14; C10M 101/02; C10M 143/12; C10M 145/14; C10M 135/18; C10M 133/44; C10M 129/10; C10M 135/10; C10M 129/26; C10M 137/10; C10M 129/54; C10M 133/04; C10M 2203/1006; C10M 2205/06; C10M 2209/084; C10M 2219/068; C10M 2215/223; C10M 2207/023; C10M 2219/044; C10M 2207/10; C10M 2223/045; C10M 2207/144; C10M 2215/02; C10N 2230/06; C10N 2230/04; C10N 2230/10; F01M 9/10

(57) ABSTRACT

The present application concerns a method for separate lubrication of a drive system for a motor vehicle, the system including a compressor and an internal combustion engine including a top end and a bottom end that are coupled together, the method including: —lubricating the bottom end with a lubricating composition CL1 having an SAE J300 grade defined by the formula (X)W−(Y) in which X represents 0 or 5 and Y represents 4, 8, 12, 16 or 20; —lubricating the top end with a lubricating composition CL2 different from the lubricating composition CL1; and —lubricating the compressor with a lubricating composition CL2 or with a lubricating composition CL3 different from the lubricating compositions CL1 and CL2.

The present invention relates to a lubrication method for separate lubrication of a drive system for a motor vehicle.

The lubricating compositions for drive systems must fulfill a number of objectives that are sometimes contradictory. These objectives stem from the five main functions of lubricating compositions for engines, these being lubrication, cooling, sealing, anti-corrosion protection and pressure transmission.

The lubrication of components/parts that slide over one another plays a critical determining role, in particular for reducing friction and wear, thereby allowing in particular for savings with respect to motor fuel.

Another essential requirement for lubricating compositions for a drive system involve aspects related to the environment. It has in fact become essential to reduce automobile fuel consumption, in particular with a view to reducing CO₂ emissions. It is also important to reduce emissions of harmful gases, for example by formulating lubricating compositions in a manner such that the catalyst remains fully functional throughout its entire lifetime. It is also equally important to limit or avoid the use of toxic additives in order to reduce or limit their elimination, for example by means of reprocessing, post-treatment or combustion.

Thus, the nature of the lubricating compositions for a drive system has an influence on the emission of pollutants and on automobile fuel consumption. The lubricating compositions for a drive system that enable achieving of energy savings are often referred to as “fuel eco [fuel economy]” (FE) according to the accepted terminology. Such “fuel eco” oils have been developed in order to satisfy these new needs.

The majority of current motor vehicles are equipped with a drive system in which a single lubricating composition is used to lubricate the various different constituent members of the said drive system.

However, the characteristic features and constraints of the various component members to be lubricated in the same given drive system are different. Due to the current practice of using a single lubricating composition, the latter is not specifically adapted to the different members to be lubricated but presents a compromise between all of the characteristic features and constraints of the members to be lubricated. The gains obtained in Fuel Eco are therefore not optimal.

Thus there is an interest in being able to develop drive systems that provide for separate lubrication of the various different component members and to develop lubrication methods for separate lubrication of the different component members of drive systems.

One object of the present invention is to enable achieving a significant gain in Fuel Eco, in particular a gain of at least 3% in Fuel Eco, in the lubrication of drive systems for motor vehicles.

Another object of the invention is to make possible the operational implementation of lubricating compositions that are specific and adapted to the various different component members to be lubricated, in the said drive system for a motor vehicle.

Other objectives shall become apparent upon reading the description of the invention that follows.

These objectives are fulfilled by the present invention which provides a lubrication method for separate lubrication of a drive system for a motor vehicle, the said system comprising an internal combustion engine that comprises an engine top part (or top end) and an engine bottom part (or bottom end) that are coupled together, the said method comprising:
the lubrication of the engine bottom part with a lubricating composition (CL1) having an SAE J300 grade, defined by the formula (X)W−(Y) in which X represents 0 or 5 and Y represents 4, 8, 12, 16 or 20; and
the lubrication of the engine top part with a lubricating composition (CL2) that is different from the lubricating composition (CL1).

In the context of the present invention, the term “separate lubrication” is understood to indicate the fact that there are separate lubricating compositions according to the component members to be lubricated, typically at least two separate lubricating compositions, one for lubrication of the elements of the engine top part (top end) and the other for lubrication of the elements of the engine bottom part (bottom end). In an advantageous fashion, as indicated here below, the drive system comprises at least two separate lubrication systems, with one supplying the engine top part, and the second supplying the engine bottom part.

In the context of the present invention, the term “separate lubricating compositions” or “different lubricating compositions”, are understood to refer to lubricating compositions which are differentiated from each other by their constituent elements, in particular by the nature of their constituent elements, and/or by the proportions of the various different constituent elements of the compositions.

In an advantageous fashion, this method makes it possible to have lubricants optimised at the level of the engine bottom part and at the level of the engine top part.

In the context of the present invention, the term “engine top part” (top end) is understood to refer to the part of the engine that is constituted of the cylinder head or cylinder heads which are assembled on to the engine bottom part. The cylinder head is the seat for the distribution of the intake gases in the combustion chamber, through the intake pipe and intake valves, and for the discharge of the combustion gases, through an exhaust pipe and exhaust valves.

In the context of the present invention the term “engine bottom part” (bottom end) is understood to refer to the part of the engine that comprises a moveable coupling (connecting rods, pistons, and the crankshaft) within an “engine block” containing the cylinders, and a housing containing the engine lubricant.

The boundary between the “engine bottom part” and the “engine top part or top parts” is manifested in the one or more seal(s) of the cylinder head.

In the following sections, the terms “top”, “upper” and equivalents thereof, are used to denote a direction vertically oriented towards the top of the vehicle when it is in a position of use, in which it rests for example on the ground. The terms “bottom”, “lower” and equivalents thereof, are used to denote the opposite direction.

By way of a variant, the invention is also applicable to engines having a spatial configuration that is different from that of the examples of the drive systems described here above, in particular so-called “flat” engines. It is understood that in the case of these particular engines, the engine top part is not necessarily placed above the engine bottom part. Thus, in the case of these particular engines, the term “engine top part” defined here above is used to refer to the cylinder head, in particular equipped with one or more control shaft(s), and with the distribution system, the term “engine bottom part” is used to refer to the crankcase and the engine block, in particular equipped with pistons, connecting rods, crankshaft, cylinders and combustion chambers.

In one particular embodiment, the invention relates to a lubrication method for separate lubrication of a drive system for a motor vehicle, the said system comprising a compressor, preferably a turbo compressor, an internal combustion engine comprising an engine top part and an engine bottom part that are coupled together, the said method comprising:
the lubrication of the engine bottom part with a lubricating composition (CL1) having an SAE J300 grade, defined by the formula (X)W−(Y) in which X represents 0 or 5 and Y represents 4, 8, 12, 16 or 20;
the lubrication of the engine top part with a lubricating composition (CL2) that is different from the lubricating composition (CL1); and
the lubrication of the compressor with a lubricating composition (CL2) or with a lubricating composition (CL3) that is different from the lubricating compositions (CL1) and (CL2).

Preferably, in the context of the invention, the composition (CL1) has an SAE J300 grade, selected from 0W-4, 0W-8, 0W-12, 0W-16, 0W-20, 5W-4, 5W-8, 5W-12, 5W-16 or 5W-20, preferably selected from 0W-8, 0W-12, 0W-16, 0W-20, 5W-8, 5W-12, 5W-16 or 5W-20.

Preferably, in the context of the invention, the composition (CL1) has an HTHS (high temperature high-shear viscosity measurement) at 150° C. that is at most equal to 2.9 mPa·s, preferably comprised between 1.4 and 2.75 mPa·s, preferably comprised between 1.7 and 2.75 mPa·s.

The HTHS measurement is carried out at high shear (10⁶ sec⁻¹) and at high temperature in accordance with the standardised methods CEC-L-36-A-90, ASTM D4683 and ASTMD4741.

Preferably, the compositions (CL1), (CL2) and (CL3) according to the invention comprise at least one base oil and additives, it being understood that the compositions (CL1), (CL2) and (CL3) are different from one another, that is to say they comprise different base oils and/or different additives and/or different proportions of base oil and/or additives.

The base oils used in the lubricating compositions according to the invention may be oils of mineral or synthetic origins belonging to the Groups I to V according to the classes defined in the American Petroleum Institute (API) classification (or equivalents thereof according to the Association Technique de L'Industrie Européenne des Lubrifiants/Technical Association of the European Lubricants Industry (ATIEL) classification) (Table A) or mixtures thereof.

TABLE A

| | | | Viscosity |
|---|---|---|---|
| | Saturates | Sulfur | Index |
| | Content | Content | (VI) |
| Group I | <90% | >0.03% | 80 ≤ VI < 120 |
| Mineral Oils | | | |
| Group II | ≥90% | ≤0.03% | 80 ≤ VI < 120 |
| Hydrocracked | | | |
| Oils | | | |
| Group III | ≥90% | ≤0.03% | ≥120 |
| Hydrocracked | | | |
| Or Hydro- | | | |
| Isomerised Oils | | | |

| | |
|---|---|
| Group IV | Polyalphaolefin (PAO) |
| Group V | Esters and Other Bases not included in Groups I to IV |

The mineral base oils according to the invention include all types of base oils obtained by means of atmospheric and vacuum distillation of crude oil, followed by refining operations such as solvent extraction, deasphalting, solvent dewaxing, hydrotreating, hydrocracking, hydroisomerisation, and hydrofinishing.

Mixtures of synthetic and mineral oils may also be used.

The base oils of the lubricating compositions according to the invention may also be selected from among synthetic oils, such as certain carboxylic acid esters and alcohol esters, and from polyalphaolefins. The polyalphaolefins used as base oils are for example obtained from monomers comprising from 4 to 32 carbon atoms, for example from octene or decene, and whereof the kinematic viscosity at 100° C. (KV100) is comprised between 1.5 and 15 mm²·s⁻¹ in accordance with the American Society for Testing and Materials standard ASTM D445. Their average molecular weight is generally comprised between 250 and 3000 in accordance with the ASTM D5296 standard.

The lubricating compositions according to the invention may comprise at least 50% by weight of base oils in relation to the total weight of the composition. In a more advantageous manner, the lubricating composition according to the invention comprises at least 60% by weight, or even at least 70% by weight, of base oils in relation to the total weight of the composition. In a particularly more advantageous manner, the lubricating composition according to the invention comprises from 75 to 99.9% by weight of base oils in relation to the total weight of the composition.

The preferred additives for the lubricating compositions according to the invention are selected from among detergent additives, anti-wear additives, friction modifier additives, extreme pressure additives, dispersants, pour point improvers, anti-foaming agents, thickeners and mixtures thereof.

In a preferred manner, the lubricating compositions according to the invention comprise at least one anti-wear additive, at least one extreme pressure additive or mixtures thereof. In a particularly preferred fashion, the lubricating composition (CL1) does not include any anti-wear additives.

The anti-wear additives and extreme pressure additives protect the surfaces in frictional contact by the formation of a protective film that is adsorbed on these surfaces.

There exists a wide variety of anti-wear additives. In a preferred manner, for the lubricating composition according to the invention, the anti-wear additives are selected from among phospho-sulfurised additives such as metal alkylthiophosphates, in particular zinc alkylthiophosphates, and more specifically zinc dialkyldithiophosphates or ZnDTP. The preferred compounds are those having the formula Zn((SP(S)(OR₇)(OR₈))₂, wherein R₇ and R₈, which may be identical or different, independently represent an alkyl group, preferably an alkyl group having from 1 to 18 carbon atoms. The amine phosphates are also anti-wear additives that may be employed in the lubricating composition according to the invention. However, the phosphorus provided by these additives may act as poison for the catalytic systems of the automobiles because these additives are prone to generating ashes. It is possible to minimise these effects by partially substituting the amine phosphates with additives that do not contribute any phosphorus, such as, for example, polysulfides, in particular sulfurised olefins.

In an advantageous manner, the lubricating compositions according to the invention may comprise from 0.01 to 6% by weight, preferably from 0.05 to 4% by weight, more preferably from 0.1 to 2% by weight in relation to the total weight of the lubricating composition, of anti-wear additives and extreme pressure additives. In a particularly preferred fashion, the lubricating composition (CL1) does not include any anti-wear additive. Advantageously the lubricating composition (CL1) does not include any anti-wear additive of such types as: ZnDTP (zinc dithiophosphate), MoDTP (molybdenum dithiophosphate), or sulfurised olefins.

In an advantageous manner, the lubricating compositions according to the invention may comprise at least one friction modifier additive. The friction modifier additive may be selected from a compound that provides metal elements and a compound free of ashes. Among the compounds providing metal elements, mention may be made of transition metal complexes such as Mo, Sb, Sn, Fe, Cu, Zn whose ligands may be hydrocarbon compounds containing atoms of oxygen, nitrogen, sulfur or phosphorus. The friction modifier additives that are ash-free are usually of organic origin and may be selected from among monoesters of fatty acids and of polyols, alkoxylated amines, alkoxylated fatty amines, fatty epoxides, borated fatty epoxides; fatty amines, or fatty acid glycerol esters. According to the invention, the fatty compounds comprise at least one hydrocarbon group having from 10 to 24 carbon atoms.

In an advantageous manner, the lubricating compositions according to the invention may comprise from 0.01 to 2% by weight or from 0.01 to 5% by weight, preferably from 0.1 to 1.5% by weight or from 0.1 to 2% by weight in relation to the total weight of the lubricating composition, of friction modifier additive.

In an advantageous manner, the lubricating compositions according to the invention may comprise at least one antioxidant additive.

The antioxidant additive generally provides the means to delay the degradation of the lubricating composition in service. This degradation may in particular be reflected in the formation of deposits, by the presence of sludge or by an increase in the viscosity of the lubricating composition.

The antioxidant additives act in particular as free radical inhibitors or destroyers of hydroperoxides. Among the types of antioxidant additives commonly used, mention may be made of phenolic antioxidant additives, amine antioxidant additives, phosphorosulphur antioxidant additives. Certain of these antioxidant additives, such as phosphorosulphur antioxidant additives may be prone to generating ashes. The phenolic antioxidant additives may be ash-free or indeed in the form of neutral or basic metal salts. The antioxidant additives may be selected from among sterically hindered phenols, sterically hindered phenolic esters and sterically hindered phenols comprising a thioether bridge, diphenylamines, diphenylamines substituted by at least one C₁-C₁₂ alkyl group, N,N′-dialkyl-aryl diamines and mixtures thereof.

Preferably according to the invention, the sterically hindered phenols are selected from among compounds comprising a phenol group in which at least one carbon atom that is vicinal to the carbon bearing the alcohol function is substituted by at least one C₁-C₁₀ alkyl group, preferably a C₁-C₆ alkyl group, preferably a C₄ alkyl group, preferably by the tert-butyl group.

Amine compounds are another class of antioxidant additives that may be used, possibly in combination with phenolic antioxidant additives. Examples of amine compounds are aromatic amines, for example, aromatic amines having the formula NR^{a}R^{b}R^{c} wherein R^{a} represents an aliphatic group or an aromatic group, possibly substituted, R^{b} represents an aromatic group, possibly substituted, R^{c} represents a hydrogen atom, an alkyl group, an aryl group, or a group having the formula R^{d}S(O)_{z}R^{e} wherein R^{d} represents an alkylene group or an alkenylene group, R^{e} represents an alkyl group, an alkenyl group or an aryl group, and z represents 0, 1 or 2.

Sulfurised alkyl phenols or the alkali metal salts and alkaline earth metal salts thereof may also be used as antioxidant additives.

Another class of antioxidant additives is that of copper compounds, for example thio- or dithio-phosphates of copper, copper salts and carboxylic acid salts, dithiocarbamates, sulphonates, phenates, copper acetylacetonates. Copper(I) and copper(II) salts, acid salts or succinic anhydride salts may also be used.

The lubricating compositions according to the invention may contain all types of antioxidant additives known to the person skilled in the art.

In an advantageous manner, the lubricating compositions comprise at least one ash-free antioxidant additive.

Also in an advantageous manner, the lubricating compositions according to the invention comprise from 0.1 to 2% by weight in relation to the total weight of the composition, of at least one antioxidant additive.

The lubricating compositions according to the invention may also comprise at least one detergent additive.

The detergent additives generally make it possible to reduce the formation of deposits on the surface of metal parts by way of dissolving secondary products of oxidation and combustion.

The detergent additives used in the lubricating compositions according to the invention are generally known to the person skilled in the art. The detergent additives may be anionic compounds comprising a lipophilic long hydrocarbon chain and a hydrophilic head. The associated cation may be a metal cation of an alkali metal or alkaline earth metal.

The detergent additives are preferably selected from among alkali metal salts or alkaline earth metal salts of carboxylic acids, sulfonates, salicylates, naphthenates, as well as the salts of phenates. The alkali metals and alkaline earth metals are preferably calcium, magnesium, sodium or barium.

These metal salts generally contain the metal in a stoichiometric quantity or indeed in excess, hence in a quantity in excess of the stoichiometric quantity. These are then overbased detergent additives; the metal in excess providing the overbased character to the detergent additive is then generally in the form of an insoluble metal salt in the oil, for example a carbonate, a hydroxide, an oxalate, an acetate, a glutamate, preferably a carbonate.

In an advantageous manner, the lubricating compositions according to the invention may comprise from 0.5 to 8% or from 2 to 4% by weight of detergent additive in relation to the total weight of the lubricating composition.

In an equally advantageous manner, the lubricating composition according to the invention may also comprise at least one pour point depressant additive (Pour Point Depressant PPD).

By slowing down the formation of paraffin crystals, pour point depressant additives generally improve the cold temperature behaviour of the lubricating composition according to the invention.

By way of examples of pour point depressant additives mention may be made of alkyl polymethacrylates, polyacrylates, polyarylamides, polyalkylphenols, polyalkylnaphthalenes, alkylated polystyrenes.

In an advantageous manner, the lubricating compositions according to the invention may also comprise at least one dispersing agent.

The dispersing agent may be selected from Mannich bases, succinimides and derivatives thereof.

Also in an advantageous manner, the lubricating compositions according to the invention may comprise from 0.2 to 10% by weight of dispersing agent in relation to the total weight of the lubricating composition.

In an advantageous manner, the lubricating compositions may also comprise at least one polymer that improves the viscosity index. By way of examples of polymeric viscosity index improver, mention may be made of polymeric esters, homopolymers or copolymers, either hydrogenated or non-hydrogenated, of styrene, butadiene and isoprene, polymethacrylates (PMA). In an equally advantageous manner, the lubricating compositions of the invention may comprise from 1 to 15% by weight in relation to the total weight of the lubricating composition, of the polymeric viscosity index improver.

For example, the composition (CL1) is a 0W-20 grade composition, for example Quartz 9000 Future 0W-20 or Quartz V-drive 0W-20®.

For example, the composition (CL2) is a 5W-30 grade composition, for example Quartz Ineo MC3 5W-30®.

For example, the composition (CL3) is a 5W-40 grade composition, for example Quartz 9000 5W-40®.

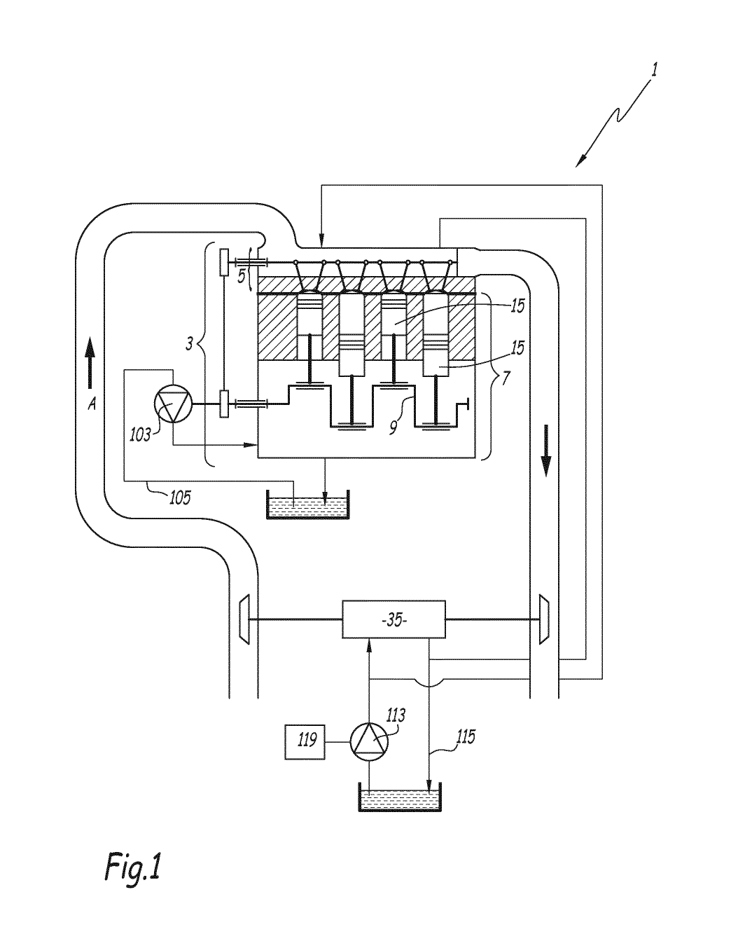

FIG. 1 is a schematic view of a drive system which is capable of enabling the implementation of the method according to the invention.

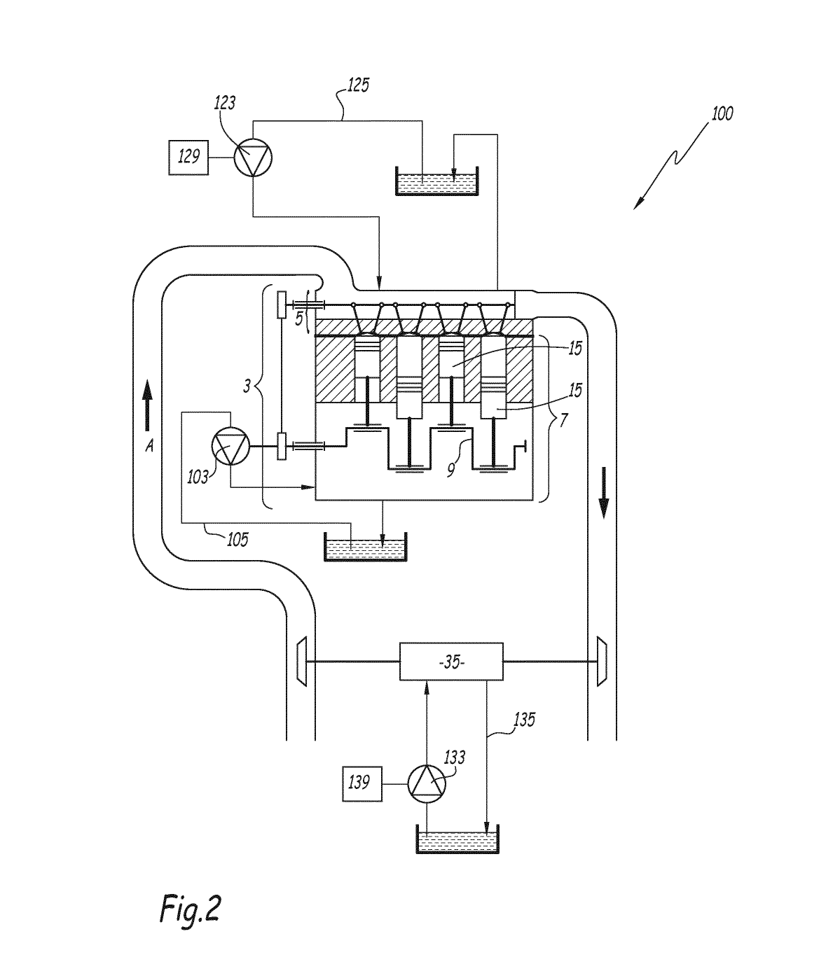

FIG. 2 is a schematic view of a drive system which is capable of enabling the implementation of the method according to the invention.

The drive system 1 shown in FIG. 1 is designed so as to equip a motor vehicle, for example a land-based motor vehicle, such as a car.

The present invention also relates to a lubrication method for separate lubrication of a drive system 1, 100 for a motor vehicle comprising:
an internal combustion engine 3, which comprises an engine top part 5 and an engine bottom part 7 that are coupled together, as well as a driving power train including at least one piston 15 and a crankshaft 9;
a compressor 35, which is fitted to the internal combustion engine, and which is designed for compressing, at least in part, an inlet fluid A intended for filling cylinders of the engine bottom part,
   the said method comprising:
the lubrication of the engine bottom part with a lubricating composition (CL1), by making use of a main lubrication system comprising a main circuit 105 and a main pump 103;
the lubrication of the engine top part with a lubricating composition (CL2) and/or of the compressor with a lubricating composition (CL2), by making use of a secondary lubrication system comprising at least one secondary circuit 115, 125, 135 which is separate from the main circuit, at least one secondary actuator 119, 129, 139 that drives a secondary pump 113, 123, 133.

In an advantageous fashion, the secondary actuator is mechanically independent from the driving power train.

The present invention also relates to a lubrication method for separate lubrication of a drive system 1, 100 for a motor vehicle comprising:
an internal combustion engine 3, which comprises an engine top part 5 and an engine bottom part 7 that are coupled together, as well as a driving power train including at least one piston 15 and a crankshaft 9;
a compressor 35, which is fitted to the internal combustion engine, and which is designed for compressing, at least in part, an inlet fluid A intended for filling cylinders of the engine bottom part,
   the said method comprising:
the lubrication of the engine bottom part with a lubricating composition (CL1), by making use of a main lubrication system comprising a main circuit 105 and a main pump 103;
the lubrication of the engine top part with a lubricating composition (CL2) by making use of a first secondary lubrication system 125 which is separate from the main circuit, comprising a first secondary pump 123; and
the lubrication of the compressor with a lubricating composition (CL3), by making use of a second secondary lubrication system 135 which is separate from the first secondary circuit, comprising a second secondary pump 133, which is distinct and separate from the first secondary pump.

The compressor may be in particular a turbocharger compressor.

The present patent application will now be illustrated by making use of non-limiting examples presented here below.

The lubrication method according to the present invention has been operationally implemented in the drive system represented in FIG. 2, the engine used being a DW10 engine from the automaker PSA Peugeot Citroen. Two tests were carried out with the compositions (CL1) and (CL2) that are distinct from one another.

In these tests:
the engine bottom part 7 is lubricated with a lubricating composition (CL1), by making use of a main lubrication system comprising a main circuit 105 and a main pump 103;
the engine top part 5 corresponding to the cylinder head is lubricated with a lubricating composition (CL2) by making use of a first secondary lubrication system 125 which is separate from the main circuit, comprising a first secondary pump 123; and
the compressor 35 corresponding to a turbocharger compressor is lubricated with the lubricating composition (CL2), by making use of a second secondary lubrication system 135 which is separate from the first secondary circuit, comprising a second secondary pump 133, which is distinct and separate from the first secondary pump.

The lubricating compositions used in operation are described in Table I here below:

TABLE I

| | | Test 1 | Test 2 |
|---|---|---|---|
| CL1 | Group III Base Oil | 85 | 82.8 |
| | (KV100 measured | | |
| | according to the | | |
| | standard | | |
| | ASTMD445 = 4.1 | | |
| | mPa · s) | | |
| | Additives (friction | 11.2 | 11.2 |
| | modifier, type: | | |
| | molybdenum | | |
| | dithiocarbamate; | | |
| | PPD, type: | | |
| | polymethacrylate; | | |
| | dispersant, type: | | |
| | succinimide; | | |
| | detergents, type: | | |
| | phenate, sulfonate | | |
| | and carboxylate) | | |
| | Polymer 1 | 3.8 | |
| | (hydrogenated | | |
| | styrene/isoprene | | |
| | copolymer) | | |
| | Polymer 2 | | 6 |
| | (polymethacrylate) | | |
| CL2 | Base Oil 1 (group III | 37.4 | 37.4 |
| | base oil with a | | |
| | KV100 measured | | |
| | according to the | | |
| | standard | | |
| | ASTMD445 = 4.1 | | |
| | mPa · s) | | |
| | Base Oil 2 (Group | 15 | 15 |
| | III base oil with a | | |
| | KV100 measured | | |
| | according to the | | |
| | standard | | |
| | ASTMD445 = 5.1 | | |
| | mPa · s) | | |
| | Base Oil 3 (Group | 30 | 30 |
| | IV base oil with a | | |
| | KV100 measured | | |
| | according to the | | |
| | standard | | |
| | ASTMD445 = 4 | | |
| | mPa · s) | | |
| | Additives (friction | 11.5 | 11.5 |
| | modifier, type: | | |
| | molybdenum | | |
| | dithiocarbamate; | | |
| | dispersant, type: | | |
| | borated ester; anti- | | |
| | wear, type: zinc | | |
| | dithiophosphate; | | |
| | detergent, type: | | |
| | salicylate; | | |
| | antioxidants, type: | | |
| | phenol and amine) | | |
| | Polymers | 6.1 | 6.1 |
| | (hydrogenated | | |
| | styrene/isoprene | | |
| | copolymer and | | |
| | polymethacrylate) | | |

For the Test 1, the composition CL1 is defined by an SAE 0W 16 grade rated according to the SAEJ300 classification.

For the Test 2, the CL1 composition is defined by an SAE 0W-20 grade rated according to the SAEJ300 classification.

The average gain in fuel consumption for the Tests 1 and 2 was determined by effectively implementing the method here below comprising the following three steps:
Measurement of the consumption in non-separated configuration: this step consists in the measuring of consumption over stabilised points representative of the standard cycle NEDC (New European Driving Cycle) (or NCEC Nouveau Cycle Européen de Conduite) with a 0W30 grade reference oil corresponding to the composition CL2;
Measurement of the consumption in separated configuration: this step consists in repeating the same measurements of consumption over the same points of operation as those of the first step, but this time with an engine whereof the lubrication system circuit has been separated into three sub-circuits as shown in FIG. 2 dedicated respectively to the turbocharger compressor, to the cylinder head and to the engine bottom part. The turbocharger compressor circuit as well as the cylinder head circuit contain the same 0W30 grade reference oil as that of the first step corresponding to the composition CL2. As for the engine bottom part circuit it contains a candidate oil CL1.
Calculation of the relative gains in consumption over points of operation that are comparable between the candidate oil CL1 in the engine in separate lubrication configuration and the reference oil in the engine in unseparated lubrication configuration.

By means of this method, it is possible to compare, over each point of operation, the gain in fuel consumption by using a separate lubrication engine system with the candidate oil CL1 specifically formulated for the engine bottom part.

The results of the gain in fuel consumption for the Tests 1 and 2 are presented in Table II here below:

TABLE II

| | Test 1 | Test 2 |
|---|---|---|
| Average gain in fuel | 3.94% | 4.85% |
| consumption (%) | | |

The above results show that the operational implementation of a lubrication method according to the invention makes it possible to obtain significant gains in motor fuel consumption, in particular greater than 3%.

1-6. (canceled)

7. A lubrication method for separate lubrication of a drive system for a motor vehicle, the said system comprising a compressor, and an internal combustion engine that comprises an engine top part (or top end) and an engine bottom part (or bottom end) that are coupled together, the said method comprising:
the lubrication of the engine bottom part with a lubricating composition CL1 having an SAE J300 grade, defined by the formula (X)W−(Y) in which X represents 0 or 5 and Y represents 4, 8, 12, 16 or 20;
the lubrication of the engine top part with a lubricating composition CL2 that is different from the lubricating composition; and
the lubrication of the compressor with a lubricating composition CL2 or with a lubricating composition CL3 that is different from the lubricating compositions CL1 and CL2.

8. A method according to claim 7, wherein the composition CL1, has an SAE J300 grade, selected from 0W-4, 0W-8, 0W-12, 0W-16, 0W-20, 5W-4, 5W-8, 5W-12, 5W-16 or 5W-20.

9. A method according to claim 7, wherein the CL1 composition has a high temperature high-shear viscosity measurement (HTHS) at 150° C. that is at most equal to 2.9 mPa·s.

10. A method according to claim 7, wherein the lubricating composition CL1 does not include any anti-wear additives.

11. A lubrication method, according to claim 7, for lubricating a drive system (1, 100) for a motor vehicle comprising:
an internal combustion engine (3), which comprises an engine top part (5) and an engine bottom part (7) that are coupled together, as well as a driving power train including at least one piston (15) and a crankshaft (9);
a compressor (35), which is fitted to the internal combustion engine, and which is designed for compressing, at least in part, an inlet fluid (A) intended for filling cylinders of the engine bottom part,
the said method comprising:
the lubrication of the engine bottom part with a lubricating composition CL1, by making use of a main lubrication system comprising a main circuit (105) and a main pump (103);
the lubrication of the engine top part with a lubricating composition CL2 and/or of the compressor with a lubricating composition CL2, by making use of a secondary lubrication system comprising at least one secondary circuit (115, 125, 135) which is separate from the main circuit, at least one secondary actuator (119, 129, 139) that drives a secondary pump (113, 123, 133).

12. A lubrication method, according to claim 7, for lubricating a drive system (1, 100) for a motor vehicle comprising:
an internal combustion engine (3), which comprises an engine top part (5) and an engine bottom part (7) that are coupled together, as well as a driving power train including at least one piston (15) and a crankshaft (9);
a compressor (35), which is fitted to the internal combustion engine, and which is designed for compressing, at least in part, an inlet fluid (A) intended for filling cylinders of the engine bottom part,
the said method comprising:
the lubrication of the engine bottom part with a lubricating composition CL1, by making use of a main lubrication system comprising a main circuit (105) and a main pump (103);
the lubrication of the engine top part with a lubricating composition CL2 by making use of a first secondary lubrication system (125) which is separate from the main circuit, comprising a first secondary pump (123); and
the lubrication of the compressor with a lubricating composition CL3, by making use of a second secondary lubrication system (135) which is separate from the first secondary circuit, comprising a second secondary pump (133), which is distinct and separate from the first secondary pump.
